(19) United States
(12) Patent Application Publication
(10) Pub. No.: US 2023/0312053 A1
(43) Pub. Date: Oct. 5, 2023

(54) ELECTRIC BICYCLE

(71) Applicant: Ali Horuz, San Diego, CA (US)

(72) Inventor: Ali Horuz, San Diego, CA (US)

(21) Appl. No.: 18/130,623

(22) Filed: Apr. 4, 2023

Related U.S. Application Data
(60) Provisional application No. 63/327,256, filed on Apr. 4, 2022.

(51) Int. Cl. B62M 6/55; B62K 11/04; B62J 6/24; B62J 43/28; B62M 6/90; B62M 6/50

(52) U.S. Cl. CPC B62M 6/55; B62K 11/04; B62J 6/24; B62J 43/28; B62M 6/90; B62M 6/50; B62M 9/00

(57) ABSTRACT

An e-bike includes a frame defining a compartment, a battery mounted in the compartment, a main shaft mounted to the frame, a motor connected to the main shaft and configured to rotate the main shaft, a set of pedals disposed on the main shaft and configured to rotate the main shaft, and a drivetrain mounted on the frame and configured to transfer rotation of the main shaft to at least one wheel.

### CROSS-REFERENCE TO RELATED APPLICATIONS

This application claims priority under 35 U.S.C. § 120 from U.S. Patent application Ser. No. 63/327,256, filed on Apr. 4, 2022 in the United States Patent and Trademark Office, the disclosure of which is incorporated herein in its entirety by reference.

### BACKGROUND OF THE INVENTION

Bicycles are a well-known form of pedal-powered transportation. In recent years bicycles that include electric motors help move the bike have come into more prevalent use. These “e-bikes” are not without drawbacks. First, including a motor and battery increases the bike's weight, meaning that it takes more effort to move the e-bike than a conventional bicycle. This increased weight leads to compromises in design—to keep the weight manageable, the motor and battery are restricted in size, which in turn restricts the available power output. As a result, conventional e-bikes are only capable of low speeds and are unable to carry more than one rider at a time, and may not carry riders of above-average size or weight, because the motor being used is not strong enough to effectively move the e-bike while carrying such riders.

Conventional e-bikes also have safety issues. Many e-bikes use bicycle brake systems. Unfortunately, due to the significantly increased weight of an e-bike these bicycle brakes tend to wear out very quickly, requiring frequent replacement and also putting the rider in danger of riding with brakes that are not strong enough to quickly stop the bike.

E-bikes may also incur legal concerns, as they can blur the line between bicycle and motorcycle, the latter of which often requires a license to operate. Any e-bike which overcomes the concerns of power and weight of the motor may therefore be restricted from moving too quickly, or require the rider to be legally licensed.

Legal issues and licensing may also require e-bikes to share roads with cars, which can lead to other dangers, especially at night. Many e-bikes are only equipped with bicycle reflectors for low-light visibility, and these reflectors do not make an e-bike visible enough to be safe to ride at night, especially if the e-bike is legally required to be on the road alongside cars.

There is accordingly a need for an e-bike which addresses some or all of the above issues.

### SUMMARY OF THE INVENTION

Exemplary embodiments of the present general inventive concept provide an e-bike using a battery, motor, and pedals to move.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an e-bike, comprising: a frame defining a compartment, a battery mounted in the compartment, a main shaft mounted to the frame, a motor connected to the main shaft and configured to rotate the main shaft, a set of pedals disposed on the main shaft and configured to rotate the main shaft, and a drivetrain mounted on the frame and configured to transfer rotation of the main shaft to at least one wheel.

In an exemplary embodiment, the frame may include one or more polygonal structures, and the central compartment may be defined by the one or more polygonal structures.

In an exemplary embodiment, the drivetrain may comprise a first sprocket disposed on the main shaft and configured to transfer rotation of the main shaft to the at least one wheel, and a second sprocket disposed on the main shaft and configured to connect the motor to the main shaft.

In an exemplary embodiment, the e-bike may further include one or more bearings disposed on the set of pedals, the one or more bearings being configured to transfer movement of the pedals to the main shaft when the pedals are moved in a first direction, and to allow the pedals to move independent of the main shaft when the pedals are moved in a second direction opposite the first direction.

In an exemplary embodiment, the motor may be mounted to approximately the center of a lower portion of the frame.

In an exemplary embodiment, the e-bike may further include a controller configured to limit a wattage drawn by the motor to a selected amount according to a user input.

In an exemplary embodiment, the controller may be further configured to monitor a remaining charge of the battery and driving behavior of the e-bike, and to switch the motor to a regeneration function when predefined criteria are met. The regeneration function may comprise the motor converting rotation of the main shaft into electrical energy to charge the battery.

In an exemplary embodiment, the predefined criteria to switch the motor to the regeneration function may comprise the remaining battery charge falling below a predefined level.

In an exemplary embodiment, the e-bike may further include a throttle to control the motor. The predefined criteria to switch the motor to the regeneration function comprise the throttle being set to zero output while the e-bike is in motion.

In an exemplary embodiment, the controller may be configured to monitor a travel speed of the e-bike. The controller may be configured to prevent the motor from accelerating the e-bike above a preset travel speed.

In an exemplary embodiment, the e-bike may further include a light system, the light system comprising a first light panel disposed on the at least one wheel, a first connector disposed on the first light panel, and a second connector disposed on the frame. The first connector may be configured to receive electricity from the second connector while the at least one wheel is rotating.

In an exemplary embodiment, the first connector may include one or more conductive elements formed as concentric circles disposed on the at least one wheel. The second connector may include one or more pins configured to contact the conductive elements and supply electricity thereto.

In an exemplary embodiment, the light system may further include a second light panel disposed on the frame.

In an exemplary embodiment, the motor may draw between 750 watts and 15000 watts.

In an exemplary embodiment, the battery may comprise one or more prismatic cells.

In an exemplary embodiment, the e-bike may further include a user interface to control the motor and set a maximum wattage to be drawn by the motor according to a user input.

In an exemplary embodiment, the user interface may be configured to limit the maximum wattage to be drawn by the motor to one of 30%, 40%, 50%, 75%, and 100% of a maximum allowed drawn wattage, according to a user input.

In an exemplary embodiment, the user interface may include a display configured to show the user at least one of a status of the battery and a wattage drawn by the motor.

In an exemplary embodiment, the user interface may be configured to connect wirelessly with a remote access point to receive commands therefrom.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 illustrates an isometric view of an e-bike according to an exemplary embodiment of the present general inventive concept;

FIG. 2 illustrates a side view of an e-bike according to an exemplary embodiment of the present general inventive concept;

FIGS. 3A and 3B illustrate internal components of an e-bike according to an exemplary embodiment of the present general inventive concept;

FIG. 4A illustrates a drivetrain of an e-bike according to an exemplary embodiment of the present general inventive concept;

FIG. 4B illustrates a view of the drivetrain from above according to an exemplary embodiment of the present general inventive concept;

FIG. 5 illustrates a user interface of an e-bike according to an exemplary embodiment of the present general inventive concept;

FIG. 6A illustrates a view of lights on a panel over a central compartment according to an exemplary embodiment of the present general inventive concept;

FIG. 6B illustrates a rear wheel and associated light system of an e-bike according to an exemplary embodiment of the present general inventive concept;

FIG. 6C illustrates a view of a connector of a wheel of an e-bike according to an exemplary embodiment of the present general inventive concept;

FIG. 6D illustrates a view of a light system on a front wheel of an e-bike according to an exemplary embodiment of the present general inventive concept; and

FIG. 7 illustrates a connector according to an exemplary embodiment of the present general inventive concept.

### DETAILED DESCRIPTION OF EXEMPLARY EMBODIMENTS OF THE INVENTIVE CONCEPT

Reference will now be made in detail to embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Also, when a part “includes” or “comprises” an element, unless there is a particular description contrary thereto, the part can further include other elements, not excluding the other elements.

Hereinafter, one or more exemplary embodiments of the present general inventive concept will be described in detail with reference to accompanying drawings.

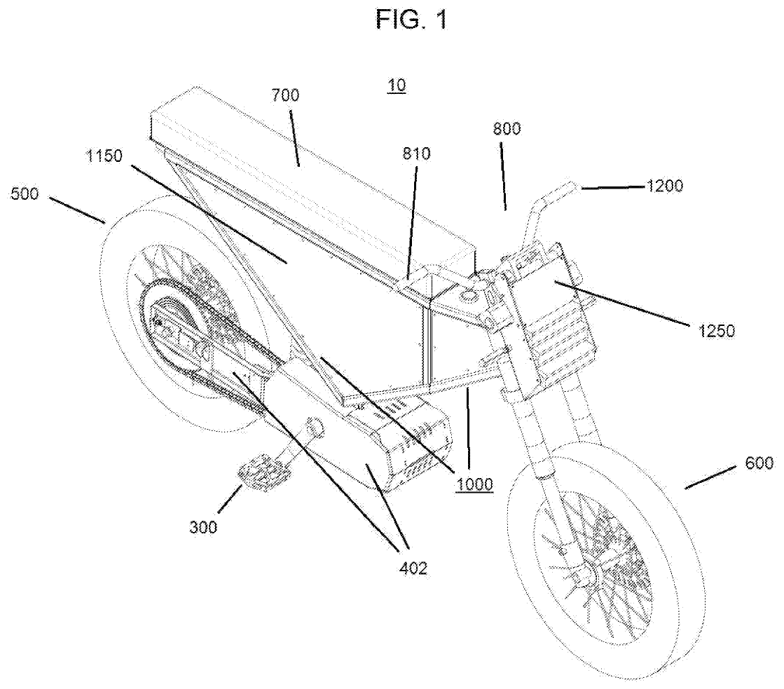

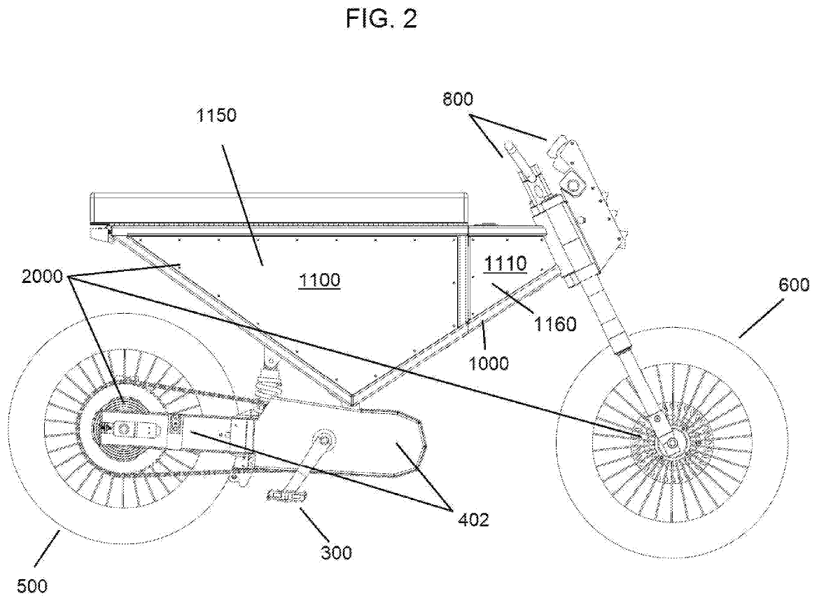

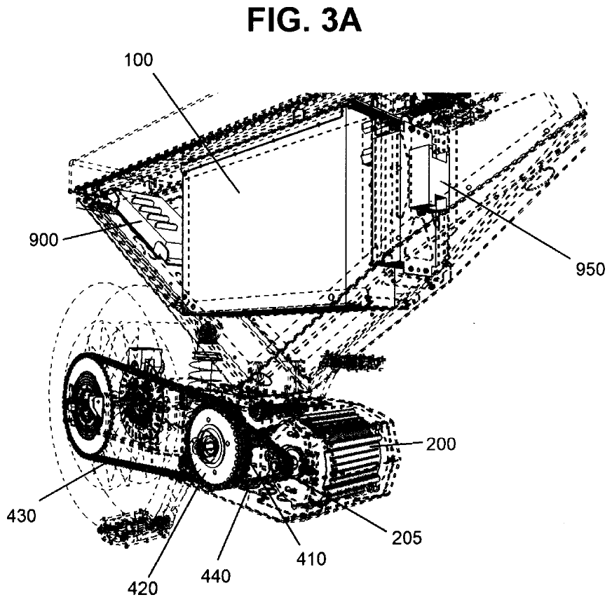

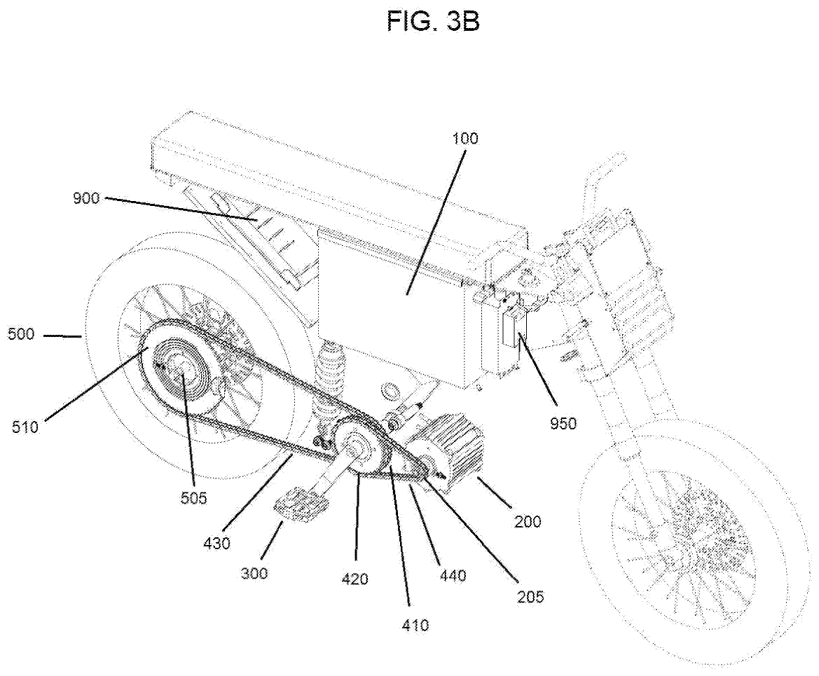

Exemplary embodiments of the present general inventive concept provide an e-bike 10 which may be referred to herein as CyberX™. FIG. 1 and FIG. 2 are respectively an isometric view and a side view of an e-bike 10 according exemplary embodiments of the present general inventive concept. As illustrated therein, the e-bike 10 may include pedals 300, a swing arm 402, rear wheel 500, front wheel 600, a seat 700, and a frame 1000, to which panels 1150 and the components of the e-bike 10 are mounted. The e-bike 10 may also include internal components such as a battery 100 and motor 200. FIG. 3A illustrates a view of the e-bike 10 with the frame 1000, panels 1150, swing arm 402, and rear wheel 500 rendered in dashed lines to show their relation to the internal components, described in detail below. FIG. 3B illustrates a view of the e-bike 10 with the frame 1000, panels 1150, and swing arm 402 invisible, for clarity of illustrating the internal components.

According to exemplary embodiments of the present general inventive concept, the battery 100 may be rated for an output between about 72 and about 84 volts and an operational life between about 32 amp-hours and about 50 amp-hours. The motor 200 may draw between about 750 watts and about 15000 watts. It will be understood that these specifications are provided only for example purposes, and other exemplary embodiments of the present general inventive concept may use a battery 100 with a different output and/or a motor 200 with a different range of wattages being drawn.

According to exemplary embodiments of the present general inventive concept, the battery 100 may power the motor 200 and other electronic components of the e-bike 10. In exemplary embodiments, the battery 100 may be mounted centrally on the e-bike 10, as illustrated in FIGS. 3A and 3B. The battery 100 may be any shape, size, or configuration suited to power the components of the e-bike 10 while fitting inside the frame 1000.

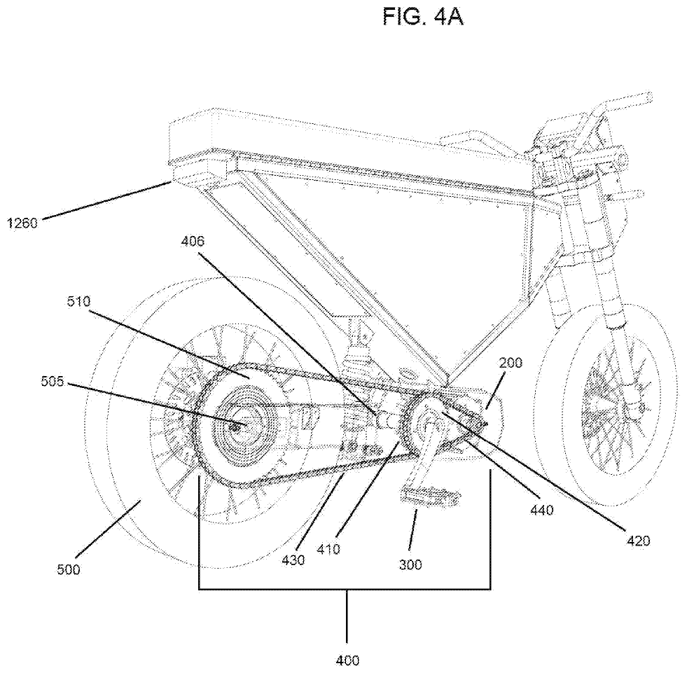

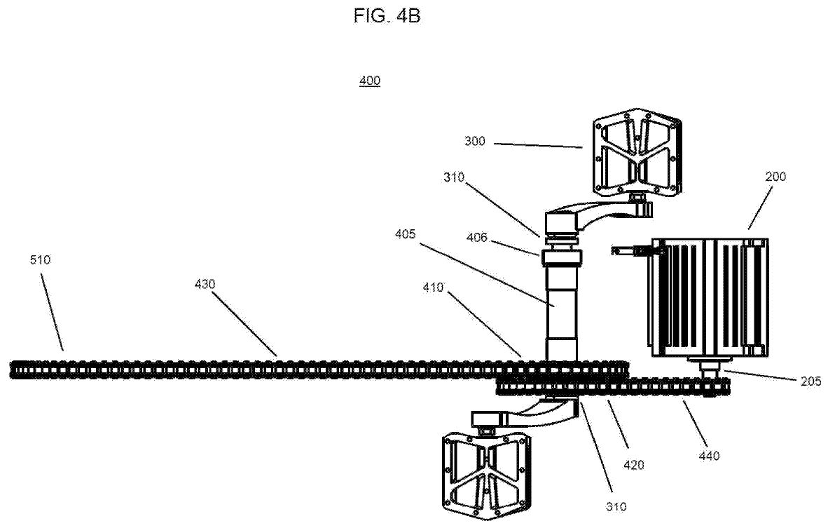

As illustrated in FIG. 2, according to an exemplary embodiment of the present general inventive concept, the frame 1000 may define a shape including one or more polygonal structures, such shape being strong enough to support a rider on the seat 700 and also define one or more open areas in the frame 1000. According to exemplary embodiments of the present general inventive concept, one open area in the frame 1000 may be a central compartment 1100 (illustrated in FIG. 2), which may be configured to hold the battery 100. The polygonal construction of the frame 1000 allows the central compartment 1100 to be made large enough to accommodate a larger battery 100 than those of conventional e-bikes, without compromising the strength of the frame 1000. This larger battery 100 may provide a corresponding increase in capacity and output thereof. Furthermore, the battery 100 may use prismatic cells, which comprise rigid rectangular casings for the individual cells in the battery which produce electricity. These rectangular casings allow prismatic cells to be more efficiently stacked within a battery than other types of cell, allowing a given volume of a battery to produce more energy with prismatic cells than with other types of cell. As a result, the battery 100 of the e-bike 10 may have a high capacity and output relative to its size or weight. The increased capacity and output of the battery 100 in turn allows the e-bike 10 to include a more powerful motor 200, since a motor's power is directly related to how much energy it can draw from the battery 100 at a given time. The larger battery 100 also provides enough electrical energy that the e-bike 10 may include safety systems such as a headlight 1250 (illustrated in FIG. 1) and taillight 1260 (illustrated in FIG. 4A) to increase visibility in low-light conditions. As a result of the larger battery 100 afforded by the frame 1000, the e-bike 10 may function more safely at night, and furthermore may have enough power to carry riders of above-average weight, or multiple riders at a time.

According to exemplary embodiments of the present general inventive concept, the motor 200 may be mid-drive, meaning it is mounted at approximately the middle of the e-bike 10. According to an exemplary embodiment of the present general inventive concept, the motor 200 may be mounted to approximately the center of a lower portion of the frame 1000 of the e-bike 10. One such exemplary embodiment is illustrated in FIGS. 3A and 3B. As illustrated therein, according to exemplary embodiments of the present general inventive concept the motor 200 may be mounted near the pedals 300 and a drivetrain 400, described in detail below with reference to FIGS. 4A and 4B.

The motor 200 may be any size or power suitable to move the e-bike 10 using electricity from the battery 100. In an exemplary embodiment of the present general inventive concept, the motor 200 may be an Internal Permanent Magnet (IPM) design, in which magnets are integrated into the internal rotors of motor. An IPM design may offer more reliable performance than other motor designs in which magnets may be affixed to the rotors with screws. Specifically, an IPM motor has reduced risk of magnets or other components coming loose while operating at high speed.

FIGS. 4A and 4B illustrates a drivetrain 400 of the e-bike 10 according to an exemplary embodiment of the present general inventive concept. The drivetrain 400 may be a system or apparatus to transfer power from the pedals 300 or motor 200 to one or both of the wheels 500 and 600 of the e-bike 10. According to exemplary embodiments of the present general inventive concept, the drivetrain 400 may be partially or completely enclosed within the swing arm 402, which may enclose the motor 200 and connect the rear wheel 500 to the frame 1000. In the exemplary embodiments illustrated in FIGS. 4A-4B, the drivetrain 400 may include a main shaft 405, which may include a set of bearings 406 directly or indirectly mounted to the frame 1000. The main shaft 405 may be free to rotate within the bearings. Among other things, the pedals 300, a first sprocket 410, and a second sprocket 420 may be disposed on the main shaft 405. According to exemplary embodiments of the present general inventive concept the first sprocket 410 and second sprocket 420 may be the same size or different sizes. The drivetrain 400 may further include a first belt 430 and a second belt 440, disposed respectively on the first sprocket 410 and the second sprocket 420. For the purposes of this application, a “belt” includes all apparatuses suitable to transfer power from the pedals 300 or motor 200 to the rear wheel 500, including bicycle chains, continuous belts, and so on.

According to exemplary embodiments of the present general inventive concept, the first sprocket 410 and the second sprocket 420 may be directly connected to the main shaft 405, such that rotation of either sprocket 410 and 420 also rotates the main shaft 405, and vice versa. According to exemplary embodiments of the present general inventive concept, the first belt 430 may connect the first sprocket 410 to the rear wheel 500, thereby allowing motion of the main shaft 405 to be transferred to the rear wheel 500. According to such exemplary embodiments, the user may use pedals 300 to rotate the main shaft 405 and transfer power to the rear wheel 500 via the first sprocket 410 and first belt 430, thereby moving the e-bike 10. According to an exemplary embodiment of the present general inventive concept, the first belt 430 may connect the first sprocket 410 to a drive sprocket 510 of the rear wheel 500, such drive sprocket 510 being disposed on a rear axle 505 of the rear wheel 500. The motion of the drive sprocket 510 may move the rear axle 505, which in turn may move the rear wheel 500.

The second belt 440 may connect the second sprocket 420 to a drive shaft 205 of the motor 200. The motor 200 may rotate the drive shaft 205, which in turn may rotate the second sprocket 420 via the second belt 440. The rotation of the second sprocket 420 may rotate the main shaft 405, which rotates the first sprocket 410 and thereby transfers power to the rear wheel 500 via the first belt 430 and drive sprocket 510. The drivetrain 400 therefore may allow the transfer of power to the rear wheel 500 via the motor 200, the pedals 300, or a combination thereof, for example by the motor 200 assisting a user who is using the pedals 300.

The pedals 300 may be connected to the main shaft 405 via one or more one-way bearings 310. The one-way bearing(s) 310 may allow the pedals 300 to transfer their movement to the main shaft 405 when the pedals 300 are rotating in a first direction, but also allow the pedals 300 to rotate freely without transferring movement to the main shaft 405 when rotating in a second direction opposite the first direction. According to exemplary embodiments of the present general inventive concept, the first direction may be the conventional pedaling direction used to drive a bicycle forwards. With the one-way bearing(s) 310, the pedals 300 may be used to move the main shaft 405 in the first direction, but the opposite is not true. That is, if the main shaft 405 is rotating faster than the pedals 300, main shaft 405 may not move the pedals 300, since at that point the pedals 300 would effectively be rotating in the second direction relative to the main shaft 405. The effect is that a user may use the pedals 300 to transfer power to the rear wheel 500 via the drivetrain 400, but the drivetrain 400 may also move without forcing the pedals 300 to rotate with it. As a result, the user may use the pedals 300 to add power to the drivetrain 400. The user's pedaling may be combined with power added from the motor 200, such that at lower speeds the user may move the e-bike 10 exclusively with the pedals 300 or may use the pedals 300 to assist the motor 200 in moving the e-bike 10. If the drivetrain 400 begins moving faster than the pedals 300, for example if the motor 200 accelerates the e-bike 10 to a higher speed than the user can pedal, then the main shaft 405 may rotate independently of the pedals 300.

The frame 1000 may be any material or configuration suitable to support the components of the e-bike 10 and one or more riders. It will be understood that the specific shape of the frame 1000 may form a variety of ornamental or visually appealing designs which can vary based on the desired aesthetic, provided the frame 1000 leaves enough room for central compartment 1100 to hold the battery 100. According to exemplary embodiments of the present general inventive concept, the frame 1000 may be formed from tubes which are cut to size and joined together. According to other exemplary embodiments of the present general inventive concept, the frame 1000 may be formed from sheet metal which is bent into a final shape and welded together.

With reference to FIG. 2, the central compartment 1100 may include some or all of the space between the seat 700 and the drivetrain 400. The compartment 1100 may be sealed against the outside environment by one or more panels 1150 (illustrated in FIG. 1) attached to the frame 1000. According to an exemplary embodiment, the central compartment 1100 may include two or more panels 1150, disposed on either side of the e-bike 10. The compartment 1100 may house electronic components of the e-bike 10, including the battery 100. According to exemplary embodiments of the present general inventive concept, the frame 1000 may also define one or more additional compartments 1110. These additional compartment(s) 1110 may also include electronic components of the e-bike 10, for example LED controller 950 (described below with reference to FIGS. 3A and 3B). The additional compartment(s) 1110 may include panels 1160 to seal them against the outside environment.

According to exemplary embodiments of the present general inventive concept, the battery 100 may be mounted approximately centrally in the frame 1000, under the seat 700 and in central compartment 1100. Furthermore, if the battery 100 is located centrally as illustrated in FIGS. 3A and 3B, it may be disposed close to the components of the e-bike 10 requiring electricity, including but not limited to the motor 200, a controller 900, and user interface 800.

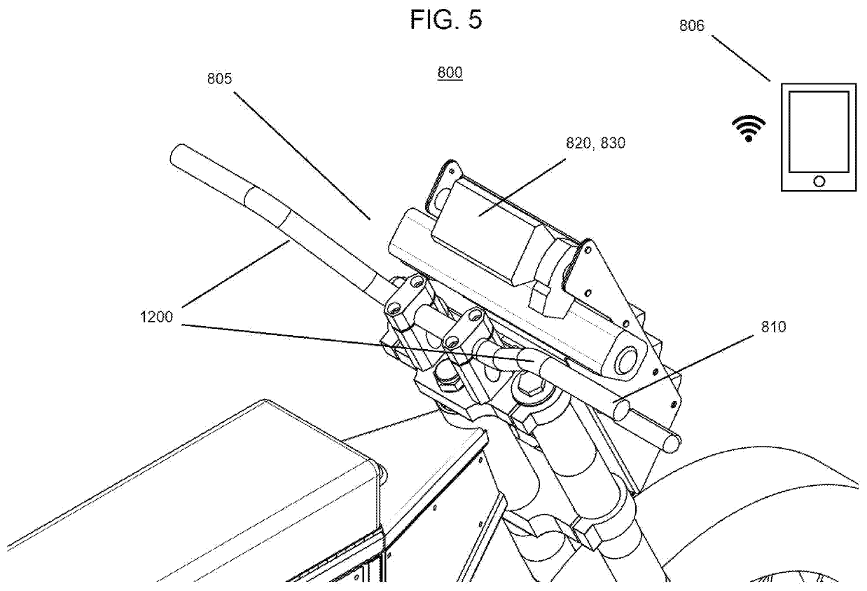

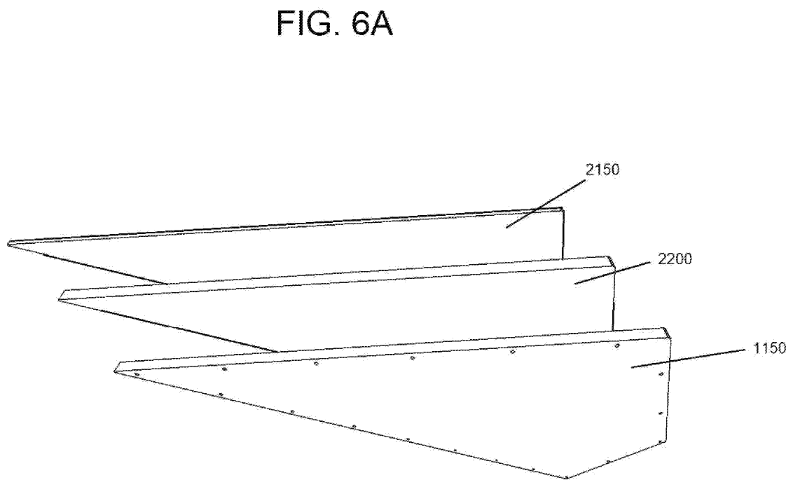

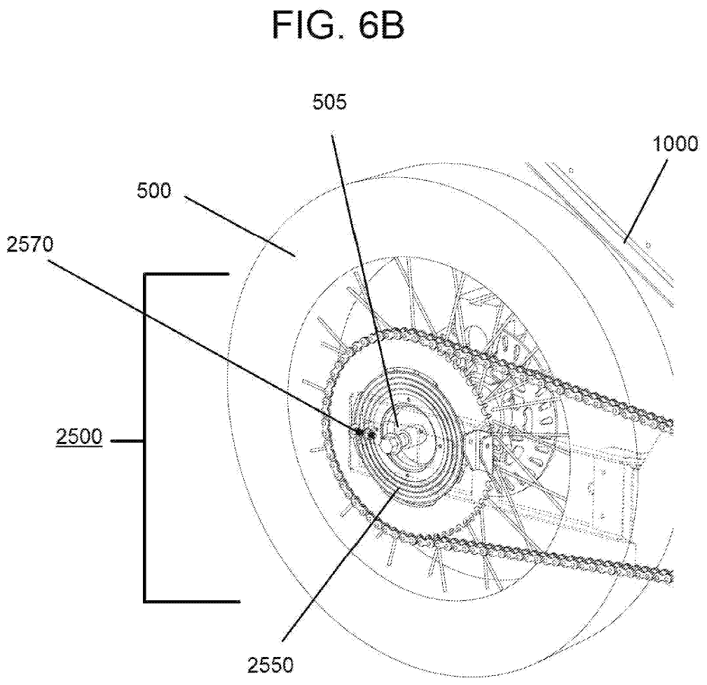

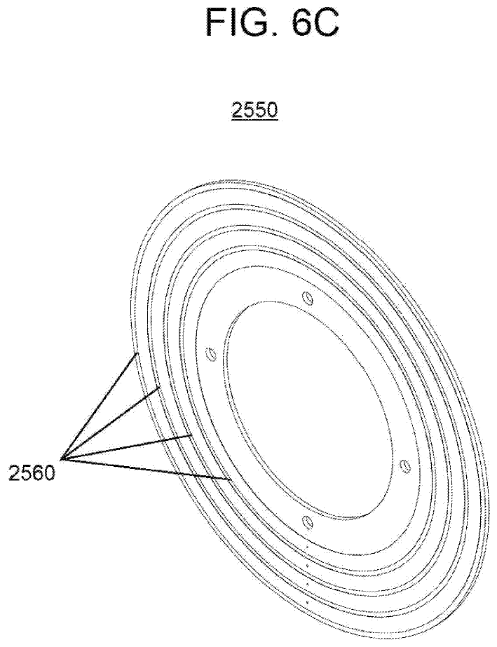

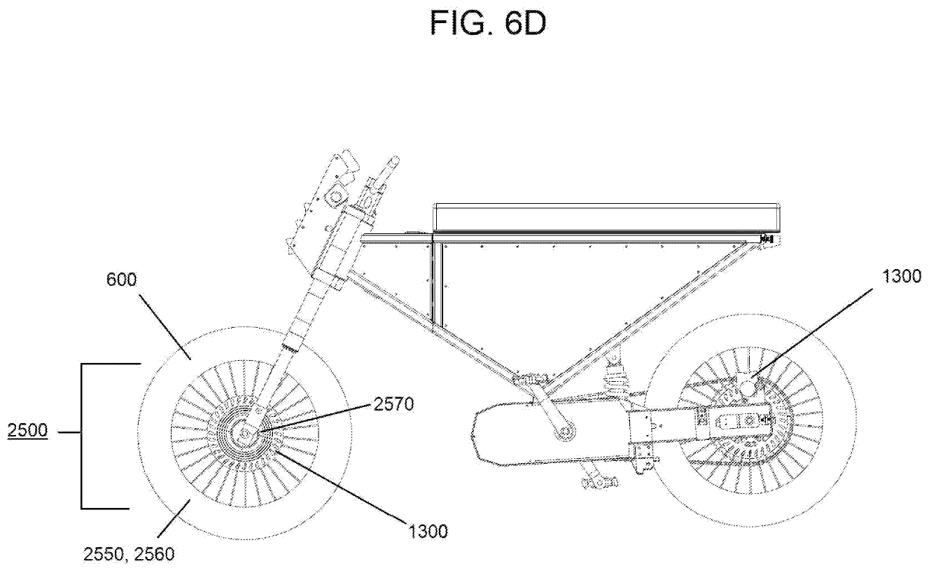

FIG. 5 illustrates a user interface 800 according to an exemplary embodiment of the present general inventive concept. The user interface 800 may be disposed on handlebars 1200 of the frame 1000. The user interface 800 may allow the user to control the functions of the e-bike 10. The user interface 800 may include controls for the motor 200, such as a throttle 810, as well as controls used for operating the e-bike 10 on a road, including for example brake controls, turn signals, and controls for headlight 1250 and/or taillight 1260. The user interface 800 may also include a display 820, for example a screen or touchscreen, to display information to the user relative to the e-bike 10's operation. This information may include, for example, the e-bike's current speed, distance traveled, charge remaining in battery 100, wattage drawn by the motor 200, etc. The user interface 800 may also allow the user to monitor and control the functions of the e-bike 10, for example switching on a headlight, controlling a lighting system 2000 (described in greater detail below with reference to FIGS. 6A-6D), checking on the status of the battery 100, defining a maximum speed, controlling wattage drawn by the motor 200, and so on.

The user interface 800 may include a main access point 805, e.g., a system disposed on the handlebars 1200 and including the throttle 810, display 820, and other controls used to operate the e-bike 10. According to exemplary embodiments of the present general inventive concept, the main access point 805 may include the display 820 as well as other controls, for example a twist handle used as the throttle 810 (illustrated in FIG. 5), as well as levers for brakes, turn signals, and so on.

According to exemplary embodiments of the present general inventive concept, the user interface 800 may also include one or more remote access points 806, for example a user's mobile device such as a smartphone. Such remote access points 806 may allow the user to wirelessly connect to the user interface 800 over a network or communications protocol such as Wi-Fi, Bluetooth, etc. via a wireless transceiver 830 on the e-bike 10. According to exemplary embodiments of the present general inventive concept, the wireless transceiver 830 may be included in the user interface 800, for example as part of the display 820. A remote access point 806 thereby allows the user to wirelessly access functions of the e-bike 10. Through such remote access points 806 the user may perform some or all of the tasks which may be performed at the main access point 805, including, for example, checking on remaining battery charge and setting limits on wattage drawn by the motor 200, described in detail below.

The user interface 800 may notify the user of the current performance of the motor 200 and battery 100. For example, the display 820 of user interface 800 may display a status of the battery 100, for example its remaining charge. The display 820 may also display a wattage currently being drawn by the motor 200 and other components of the e-bike 10. The wattage drawn at any given moment depends on multiple variables, including, for example, speed of travel, weight of the rider, road conditions, whether the e-bike 10 is riding uphill or downhill, etc. The wattage being drawn directly affects the range of the e-bike 10—as more wattage is drawn, the battery 100 is depleted more quickly, and vice versa. Therefore, the user interface 800 may allow the user to directly monitor the wattage currently being drawn, to better control their driving behavior and therefore the range of the e-bike 10. According to exemplary embodiments of the present general inventive concept, the user interface 800 may also display an estimated range for the e-bike 10, based on the current wattage being drawn by the motor 200 and/or on past driving behavior, for example based on an average wattage drawn over a given period of time.

According to exemplary embodiments of the present general inventive concept, the motor 200 may be switched to a regeneration function, meaning it may recharge the battery 100 while the e-bike 10 is motion. In a regeneration function, the motor 200 does not supply power to rotate the main shaft 405. Instead, rotation of the main shaft 405 is transferred to the motor via drivetrain 400, for example by the second sprocket 420 and second belt 440 rotating the motor's drive shaft 205. A motor 200 switched to regeneration may use this transferred rotation to produce electrical energy, similar to a generator. According to exemplary embodiments of the present general inventive concept, the motor 200 may be switched to a regeneration function if the motor 200 is not being used to move the e-bike 10, for example if the e-bike is coasting to a stop. In such a situation, even with the motor 200 not supplying power the wheels 500 and 600 continue to rotate, and this rotation may continue to move the drivetrain 400, specifically the first belt 430 and first sprocket 410, which in turn rotate the main shaft 405. The rotation of the main shaft 405 may cause the second sprocket 420 to rotate with it, and thereby transfer rotation to the motor's drive shaft 205 via second belt 440. The motor 200 may use this rotation to generate electrical energy to recharge the battery 100 while the e-bike 10 is moving. Using the motor 200 to convert motion into electricity in this way may exert resistance on the drivetrain 400, since the motor 200 would be drawing energy from the motion of the main shaft 405. As such, using the motor 200 to regenerate the battery 100 may also help to slow the e-bike 10, and thereby assist the braking of the e-bike 10, supporting the brake system 1300 and prolonging the life of brake system 1300 (illustrated in FIG. 6D). According to exemplary embodiments of the present general inventive concept, the brake system 1300 may be any brakes suitable to stop the e-bike, including for example bicycle brakes, motorcycle brakes, etc. The brake system 1300 may be located at either or both of the front wheel 600 and rear wheel 500, according to exemplary embodiments of the present general inventive concept.

In an exemplary embodiment, the e-bike 10 may include a controller 900 (illustrated in FIGS. 3A and 3B) which monitors the operations of the e-bike 10, including, e.g., the status of the motor 200 and battery 100, the speed of travel, etc. The controller 900 may furthermore control the functions of the motor 200 according to inputs from the user and according to predefined criteria. For example, the controller 900 may engage a regeneration function and begin using the motor 200 to recharge the battery 100, as detailed above. According to exemplary embodiments of the present general inventive concept, the controller 900 may engage the regeneration function when it detects that the battery 100 is at less than 50 percent capacity and throttle 810 is set to zero output, meaning the user is not using the motor 200 to move the e-bike 10. The controller 900 can also switch off the regeneration function under preset conditions. For example, the controller 900 may switch off regeneration if the throttle 810 is engaged and the motor 200 starts being used to move the e-bike 10, or if the e-bike 10 is moving at less than a preset speed, e.g., 10 miles per hour. At low speeds the e-bike 10 may be coasting to save power, or the user may be using the pedals 300 to move the e-bike 10. As such, at low speeds it may be advantageous to disable the regeneration function, so that the regeneration does not slow down the e-bike 10.

The controller 900 may also limit the motor 200 to a selected output level. For example, the controller 900 may limit the total draw from the motor 200 to a certain wattage, set based on the capabilities of the battery 100. For example, if the battery 100 can sustainably output 84 volts at 100 amps for an extended time, the controller 900 may limit the draw from the motor 200 to no more than 8400 watts. The user may also set limits on the systems of the e-bike 10. For example, through the user interface 800 the user may define a maximum draw of the motor 200 to a selected percentage of the pre-set maximum. The controller 900 would accordingly restrict the draw to no more than this defined limit. In this manner, the user may set their own limits for use of the e-bike 10, allowing the user to control the maximum speed and acceleration offered by the motor 200. By limiting the draw from the motor 200 the user may better control the range of the e-bike 10, since they are prevented from accidentally using wattage above a selected level. According to exemplary embodiments of the present general inventive concept, the controller 900 may have a plurality of pre-set modes of operation defining a maximum allowed draw from the motor 200. In such exemplary embodiments, the user may switch between pre-set modes via the user interface 800. According to one such exemplary embodiment, there may be five modes of operation, in which the motor 200 may be limited to 30%, 40%, 50%, 75%, or 100% of its maximum allowed drawn wattage. The user may select between any of these modes to control the operation of the motor 200.

The controller 900 may also limit the speed of the e-bike 10. For example, the controller 900 may be set to monitor the e-bike 10's traveling speed and limit the operation of the motor 200, for example by limiting its drawn wattage, so that the e-bike 10 does not accelerate above a pre-set speed limit. According to exemplary embodiments of the present general inventive concept, this speed limit may be set by the user via a command entered on the user interface 800. In certain locations a bike may only be classified as a “bicycle” for the purpose of licensing if it does not travel above a threshold speed, e.g., 30 miles per hour. If the e-bike 10 is restricted from traveling faster than this threshold speed, it may be legally classified as a bicycle, and therefore be exempt from licensing requirements or a requirement to ride in the road alongside cars.

Exemplary embodiments of the present general inventive concept may also provide a light system 2000 (illustrated in FIG. 2), powered by the battery 100. The light system 2000 may include one or more lighted areas in preselected portions of the e-bike 10. These portions may include, among other things, lights 2150 disposed on the one or more panels 1150 (illustrated in FIG. 6A), and/or lights 2500 disposed on one or both of the wheels 500 and 600 (illustrated in FIG. 6B).

FIG. 6A illustrates a view of the lights 2150 on one panel 1150 according to an exemplary embodiment of the present general inventive concept. As illustrated therein, lights 2150 may comprise, for example, a panel of LEDs. The lights 2150 may be disposed behind a diffuser 2200, such diffuser 2200 being disposed behind panel 1150, such that lights 2150 and diffuser 2200 are contained in the central compartment 1100. The diffuser 2200 may cause illumination from the lights 2150 to be spread out and illuminate the panel 1150 uniformly. According to exemplary embodiments of the present general inventive concept, the lights 2150 may be disposed on one or more such panels 1150, arranged as illustrated in FIG. 6A.

Each panel 1150 may further be etched, for example with a laser, to be thinner or transparent at selected portions, such that illumination from the diffuser 2200 is more prominently visible at the etched locations. Etching therefore allows each panel 1150 to be imprinted with a desired image or pattern which can be illuminated by the lights 2150.

FIG. 6B illustrates a view of the lights 2500 on the rear wheel 500. According to exemplary embodiments of the present general inventive concept, the lights 2500 may be disposed on either or both of the rear wheel 500 and the front wheel 600. The lights 2500 may include any number of LEDs, light bulbs, etc., which may be disposed anywhere on the rear wheel 500. The lights 2500 may be disposed behind a diffuser similarly to the lights 2150 disposed behind panel 1150. Alternatively, the lights 2500 may be exposed directly without a diffuser, allowing for more sharply defined illumination. As illustrated in FIG. 6B, the lights 2500 may be connected to a panel 2550 including a first connector 2560 (illustrated in FIG. 6C). The panel 2550 may be, e.g., a disc formed around the rear axle 505. The first connector 2650 may accept electricity and power one or more lights 2500 attached to the panel 2550. The first connector 2560 may include one or more exposed conductive elements which interface with a corresponding second connector 2570, which may be disposed on swing arm 402 or frame 1000. FIG. 6B illustrates one possible location for second connector 2570 according to an exemplary embodiment of the present general inventive concept.

FIG. 6D illustrates a view of a light system on a front wheel 600 of the e-bike 10 according to an exemplary embodiment of the present general inventive concept. As illustrated therein, lights 2500, including panel 2550, first connector 2650, and second connector 2570, may be included on the front wheel 600, functioning similarly to these components described above with regard to the rear wheel 500. Lights 2500 may include any number of lights disposed anywhere on front wheel 600, the exact number varying according to the exemplary embodiment of the present general inventive concept. The second connector 2570 on the front wheel 600 is illustrated as being included around the brake system 1300 disposed on the front wheel 600, but it will be understood that the location of the second connector 2570 on the front wheel 600 may vary according to different exemplary embodiments of the present general inventive concept.

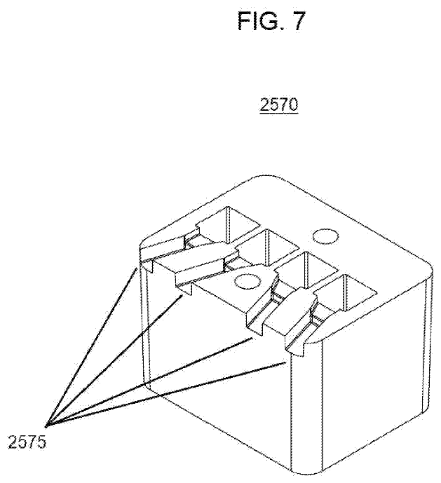

FIG. 7 illustrates the second connector 2570 according to an exemplary embodiment of the present general inventive concept. As illustrated therein, the second connector 2570 may include one or more pins 2575 which may be kept in constant contact with the first connector 2560. As illustrated in FIGS. 6B and 6C, the first connector 2560 may comprise multiple conductive elements formed as concentric circles around the hub of the wheel 500 or 600. If the second connector 2570 is disposed on the swing arm 402 or frame 1000, the pins 2575 may remain in contact with these exposed conductors while the wheel turns. Electrical power may be supplied from the battery 100 to the first connector 2560 through these pins 2575, so that the lights 2500 may receive electricity and be lit while the e-bike 10 is in motion.

An LED controller 950 (illustrated in FIGS. 3A and 3B) may control the output of lights 2150 and 2500, for example controlling color, brightness, and pattern of the lights 2150 and/or 2500. The user interface 800 may allow the user to control the lights 2150 and 2500 through this LED controller 950.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An e-bike, comprising:
a frame defining a compartment;
a battery mounted in the compartment;
a main shaft mounted to the frame;
a motor connected to the main shaft and configured to rotate the main shaft;
a set of pedals disposed on the main shaft and configured to rotate the main shaft; and
a drivetrain mounted on the frame and configured to transfer rotation of the main shaft to at least one wheel.

2. The e-bike of claim 1, wherein the frame comprises one or more polygonal structures, and
wherein the central compartment is defined by the one or more polygonal structures.

3. The e-bike of claim 1, wherein the drivetrain comprises a first sprocket disposed on the main shaft and configured to transfer rotation of the main shaft to the at least one wheel, and a second sprocket disposed on the main shaft and configured to connect the motor to the main shaft.

4. The e-bike of claim 3, further comprising one or more bearings disposed on the set of pedals, the one or more bearings being configured to transfer movement of the pedals to the main shaft when the pedals are moved in a first direction, and to allow the pedals to move independent of the main shaft when the pedals are moved in a second direction opposite the first direction.

5. The e-bike of claim 1, wherein the motor is mounted to approximately the center of a lower portion of the frame.

6. The e-bike of claim 1, further comprising a controller configured to limit a wattage drawn by the motor to a selected amount according to a user input.

7. The e-bike of claim 6, wherein the controller is further configured to monitor a remaining charge of the battery and driving behavior of the e-bike, and to switch the motor to a regeneration function when predefined criteria are met, wherein the regeneration function comprises the motor converting rotation of the main shaft into electrical energy to charge the battery.

8. The e-bike of claim 7, wherein the predefined criteria to switch the motor to the regeneration function comprise the remaining battery charge falling below a predefined level.

9. The e-bike of claim 7, further comprising a throttle to control the motor, wherein the predefined criteria to switch the motor to the regeneration function comprise the throttle being set to zero output while the e-bike is in motion.

10. The e-bike of claim 6, wherein the controller is configured to monitor a travel speed of the e-bike,
wherein the controller is configured to prevent the motor from accelerating the e-bike above a preset travel speed.

11. The e-bike of claim 1, further comprising a light system, the light system comprising a first light panel disposed on the at least one wheel, a first connector disposed on the first light panel, and a second connector disposed on the frame,
wherein the first connector is configured to receive electricity from the second connector while the at least one wheel is rotating.

12. The e-bike of claim 11, wherein the first connector comprises one or more conductive elements formed as concentric circles disposed on the at least one wheel, wherein the second connector comprises one or more pins configured to contact the conductive elements and supply electricity thereto.

13. The e-bike of claim 11, wherein the light system further comprises a second light panel disposed on the frame.

14. The e-bike of claim 1, wherein the motor draws between 750 watts and 15000 watts.

15. The e-bike of claim 1, wherein the battery comprises one more prismatic cells.

16. The e-bike of claim 1, further comprising a user interface to control the motor and set a maximum wattage to be drawn by the motor according to a user input.

17. The e-bike of claim 16, wherein the user interface is configured to limit the maximum wattage to be drawn by the motor to one of 30%, 40%, 50%, 75%, and 100% of a maximum allowed drawn wattage, according to a user input.

18. The e-bike of claim 16, wherein the user interface comprises a display configured to show the user at least one of a status of the battery and a wattage drawn by the motor.

19. The e-bike of claim 16, wherein the user interface is configured to connect wirelessly with a remote access point to receive commands.
